(19) United States
(12) Patent Application Publication
(10) Pub. No.: US 2005/0286107 A1
(43) Pub. Date: Dec. 29, 2005

(54) Electrochromic display with analog gray scale

(75) Inventor: Mark Thomas Johnson, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/524,404

(22) PCT Filed: Jul. 1, 2003
(86) PCT No.: PCT/IB03/03108

§ 371 Date: Feb. 11, 2005

(30) Foreign Application Priority Data
Aug. 15, 2002 (EP) 02078383.3

(51) Int. Cl. G02F 1/15

(52) U.S. Cl. 359/265

(57) ABSTRACT

A display device comprising a plurality of independently addressable pixels (1). Each pixel comprises: a first substrate (6); a second substrate (7); an electrochromic material (2) disposed between said first substrate (6) and said second substrate (7). At least two independent electrodes (3, 4) are associated with said first substrate (6). An independent counter-electrode (5) is associated with said second substrate (7). Each respective electrode is connected to an independently controllable voltage source. The display device has means for controlling the voltage applied to each respective electrode (3, 4, 5) for producing non-uniform electric fields in each pixel (1), for causing partial switching of the electrochromic material (2) from a first state to a second state to generate an area-ratio-defined pixel gray level.

### FIELD OF THE INVENTION

The present patent application relates to the field of electrochromic display devices and particularly to a method and apparatus for providing gray scales for such display devices. More specifically, the present patent application relates to an efficient system for providing analog gray scales for electrochromic display devices. The present patent application also relates to a computer program product comprising software code portions for achieving the system and method for providing analog gray scales for electrochromic display appliances when said product is run on a computer.

### BACKGROUND OF THE INVENTION

Electrochromic display devices have recently been studied as candidates for electronic paper type displays. However, the slow switching speed and high power consumption of the electrochromic display technologies commercially available today do not meet the needs of the display market. Of late the trend for improving performance has been the use of nano-materials such as chemically modified nano-structured mesophorous films. Use of such materials has shown promising results. However, one of the remaining key issues with respect to electrochromic displays is the generation of gray scales.

One prior art approach to providing gray scales has been to subdivide each display element (pixel) into a plurality of sub-elements using a plurality of sub-electrodes on one substrate, e.g. providing fifteen electrodes, splitting each display element into fifteen sub elements, enabling sixteen gray scale levels to be achieved by successive switching operation of each of the sub-elements for producing 15 gray scale levels and all sub-elements in their “off” condition providing the sixteenth level.

Yet another prior art approach for providing a gray scale suggests the use of circular display cells (pixels) having a curved, for example concave, exterior wall of each display cell as well as a plane base wall. By providing the curved wall with an electrode and the plane base wall with a counter-electrode there will be locations with different electrode spacing. The circular shape of the electrodes results in a concentric radial change of the area through which light can be transmitted proportionally to changes in the voltage applied. A system of this type is disclosed in WO 91 15800.

### SUMMARY OF THE INVENTION

Accordingly, it is an object of the present invention to provide an improved apparatus for providing gray scales for an electrochromic display appliance.

This object is achieved by the apparatus according to the invention as specified in claim 1.

A further object of the invention is to provide an improved method for providing gray scales for an electrochromic display appliance.

This object is achieved by the method according to the invention as specified in claim 7.

Further advantageous embodiments of the invention are specified in the dependent claims.

Yet another object of the invention is to provide an improved computer program product comprising software code portions for achieving the apparatus and method for providing gray scales for an electrochromic display appliance when said product is run on a computer.

Still other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. Further it should be understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote like elements throughout the several views:

FIG. 1 discloses a schematic cross-sectional view of a pixel of a display device according to a first embodiment of the invention with electric field lines shown;

FIG. 2 discloses a schematic cross-sectional view of the pixel of FIG. 1 with the entire electrochromic layer in a dark state;

FIG. 3 discloses a schematic cross-section of the pixel of FIG. 1 with a centrally located part of the electrochromic layer in a transparent (bright) state;

FIG. 4 discloses a schematic cross-section of the pixel of FIG. 1 with a large portion of the electrochromic layer in a dark state;

FIG. 5 discloses a schematic cross-section of the pixel of FIG. 1 with approximately half the electrochromic layer in a dark state;

FIG. 6 discloses a schematic cross-section of the pixel of FIG. 1 with a small portion of the electrochromic layer in a dark state; and

FIG. 7 discloses a schematic cross-section of the pixel of FIG. 1 with the electrochromic layer wholly in a transparent (bright) state.

### DETAILED DESCRIPTION OF PREFERRED EMBODIMENTS

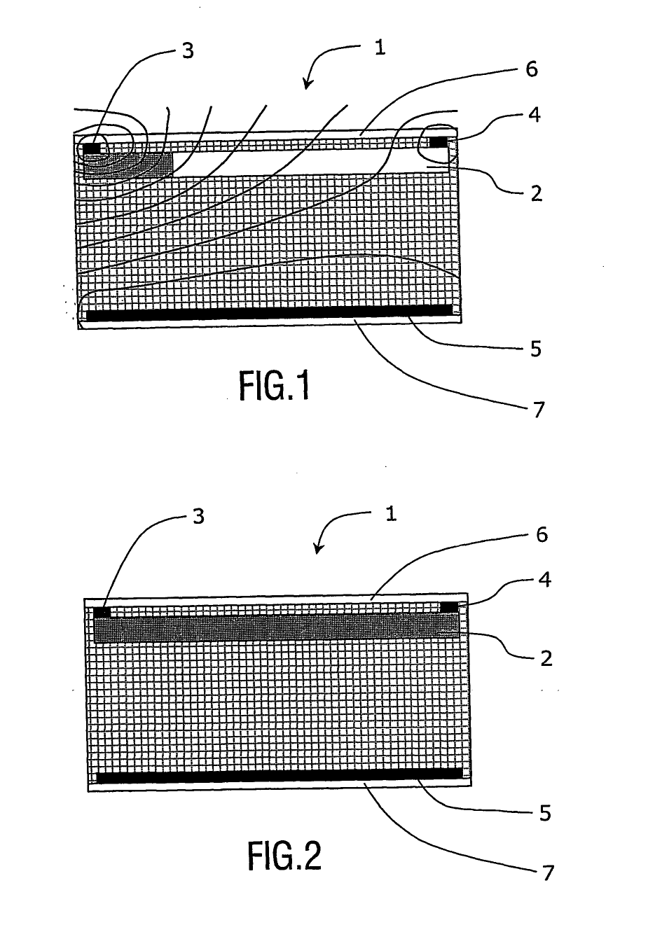

FIG. 1 shows a schematic cross sectional view of a pixel 1 of an electrochromic display according to a first embodiment. Each pixel of the electrochromic display is independently addressable and can be separated from each other either electrically or physically, in order to avoid cross-talk between pixels. The pixel 1 comprises: a first substrate 6, which is preferably transparent and made of a material such as a glass or from a plastic plate; a second substrate 7, which can also be transparent in some cases such as for a display lit at the back; an electrochromic material 2 disposed between said first substrate 6 and said second substrate 7; at least two independent conductive electrodes 3, 4 associated with said first substrate 6, which electrodes 3, 4 are preferably transparent; an independent conductive counter-electrode 5 associated with said second substrate 7. The pixel 1 also comprises a transparent electrolytic material which is in contact with said electrochromic material 2 and said counter-electrode 5. Each respective electrode 3, 4, 5 is connected to an independently controllable voltage source (not shown). The display device comprises means (not shown) for controlling the voltage applied to each respective electrode 3, 4, 5, such as u electronic display control device which can comprise a microprocessor. In this way, using the display control device, non-uniform electric fields can be produced in each pixel, e.g. as illustrated in FIG. 1 where electric field lines are shown for a case where a voltage of approximately 2V is applied to the electrode 3, while 0V is applied to electrode 4 and counter-electrode 5. These non-uniform electric fields will cause partial switching of the electrochromic material 2 from a first (preferably transparent) state to a second state (illustrated by the darker region of the electrochromic material 2). Due to the non-uniform field distribution, the charge flow will initially be concentrated to a region close to the positively charged electrode 3. In consequence, this region will switch first and the pixel 1 will be generated with part of its electrochromic material 2 in the dark state and part of it in the transparent (bright) state. In this manner an area ratio gray level can be generated in the pixel 1. The gray level generated in this way will be defined by the integral amount of charge passing into the electrochromic material 2 and hence by the time in which the electrodes 3, 4, 5 of the pixel 1 are connected to their respective voltage sources. The time required to switch to a desired state for the preferred type of display is less than 1 second. Erasure, i.e. reset, can easily be achieved through making a change of polarities. Such a reset can be used to define a reference state from which all possible gray levels can be generated. If no reset is used, it will be necessary to remember the previous state of the pixel before supplying the correct amount of charge (or discharge) to reach a new gray level. In such a case the electronic display control device will comprise memory storage means (not shown), where the previously generated gray level is stored and the new gray level to be achieved is compared with the previous gray level and the required charge (discharge) to be applied to reach the desired gray level is determined.

FIG. 2 illustrates the pixel 1 when 0V is applied to the electrodes 3 and 4, while a negative potential is applied to the counter-electrode 5. In this case the pixel 1 will be generated with all of its electrochromic material 2 in the dark state.

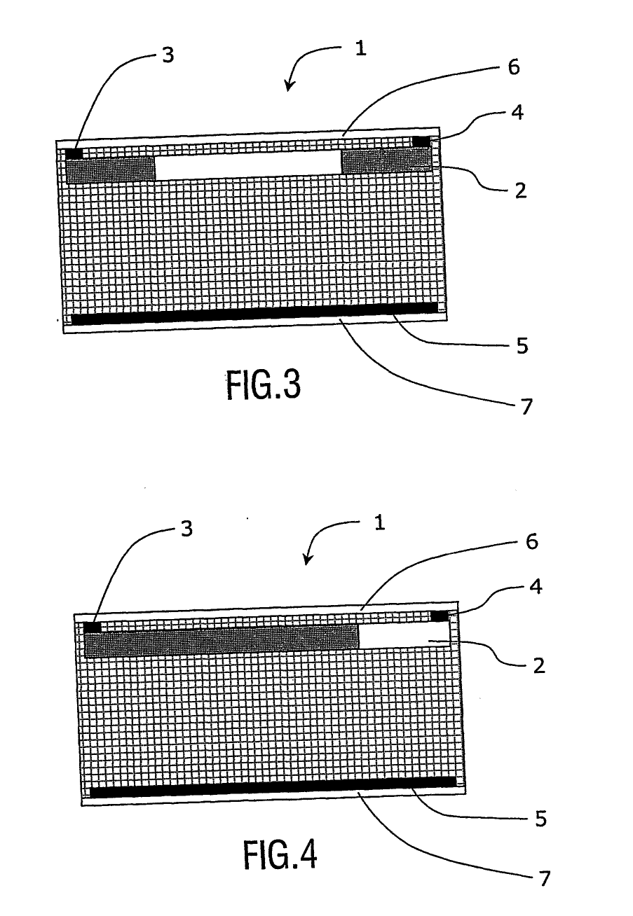

FIG. 3 illustrates the pixel 1 when moderate positive potentials are applied for a given period of time to the electrodes 3 and 4, while 0V is applied to the counter-electrode 5. In this case the pixel 1 will be generated with the regions of its electrochromic material 2 close to the positively charged electrodes 3 and 4 in the dark state and the part of its electrochromic material 2 located centrally between these electrodes 3, 4 in the transparent (bright) state.

FIG. 4 illustrates the pixel 1 when a slightly higher positive potential, compared to that of FIG. 3, is applied for the same period of time to the electrode 3 while 0V is applied to the electrode 4, and 0V is applied to the counter-electrode 5. In this case the pixel 1 will be generated with a slightly larger part of its electrochromic material 2 closest to the positively charged electrode 3 in the dark state and the part of its electrochromic material 2 located closest to the 0V electrode 4 in the transparent (bright) state.

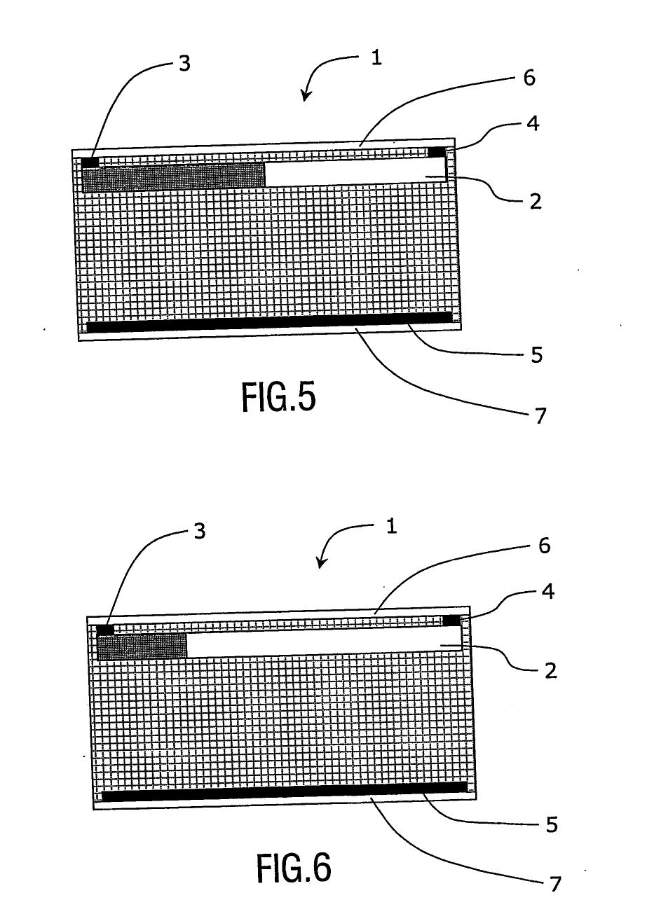

FIG. 5 illustrates the pixel 1 when a positive potential ranging between that of FIG. 3 and FIG. 4, is applied to the electrode 3 while 0V is applied to the electrode 4, and 0V is applied to the counter-electrode 5. In this case the pixel 1 will be generated with approximately half of its electrochromic material 2 closest to the positively charged electrode 3 in the dark state and the half of its electrochromic material 2 located closest to the 0V electrode 4 in the transparent (bright) state.

FIG. 6 illustrates the pixel 1 when a moderate positive potential, as that of FIG. 2, is applied to the electrode 3 while 0V is applied to the electrode 4, and 0V is applied to the counter-electrode 5. In this case the pixel 1 will be generated with a small part of its electrochromic material 2 closest to the positively charged electrode 3 in the dark state and the rest of its electrochromic material 2 located closest to the 0V electrode 4 in the transparent (bright) state. The state illustrated in FIG. 6 essentially corresponds to the state illustrated in FIG. 1.

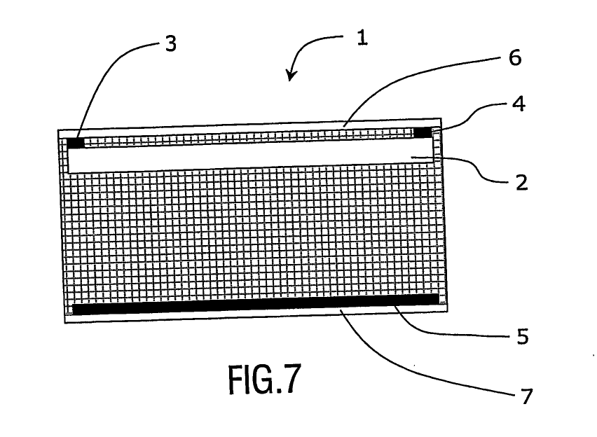

FIG. 7 illustrates the pixel 1 when 0V is applied to the electrodes 3 and 4, and a positive potential is applied to the counter-electrode 5. In this case the pixel 1 will be generated with all of its electrochromic material 2 in the transparent (bright) state.

As is evident from FIGS. 1 through 7, the use of several independently controllable electrodes in a pixel 1 of a display in accordance with the invention facilitates the possibility of achieving an analog gray level in the pixel 1 through controlling the potentials applied to the respective electrodes 3, 4, 5 and the time of application for causing an appropriate part of the electrochromic material 2 to be switched.

When using an electronic display control device comprising a micro-processor, a computer program product comprising software code portions can be used for controlling the potentials applied in accordance with the invention for providing gray scales to the electrochromic display appliance when said computer program product is run on the micro-processor of the control device.

A method for generating analog gray scales in a pixel 1 of a display device having a first substrate 6, a second substrate 7, an electrochromic material 2 disposed between said first substrate 6 and said second substrate 7, comprises the following steps: providing for at least two independent electrodes 3, 4 to be associated with said first substrate 6; providing for an independent counter-electrode 5 to be associated with said second substrate 7; providing for connection of each respective electrode 3, 4, 5 to an independently controllable voltage source; providing means for controlling the voltage applied to each respective electrode 3, 4, 5 for producing non-uniform electric fields in each pixel 1, for causing partial switching of the electrochromic material 2 from a first state to a second state for generating an area ratio gray level. The method also allows for the step of providing means for controlling the time during which voltage is applied to each respective electrode 3, 4, 5. In order to facilitate switching between gray levels the method also suggests the steps of: providing memory storage means for storing a previously generated gray level; providing means for comparing a gray level to be achieved with a previously generated gray level; providing means for determining the required potential to be applied to each respective electrode in order to reach a desired gray level.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other form or embodiment be it disclosed, described or suggested as a general matter of design choice. It is the intention, therefore, to be limited only as indicated by the scope of the claims appended hereto.

1. A display device comprising a plurality of independently addressable pixels, wherein said pixels comprise: a first substrate; a second substrate; an electrochromic material disposed between said first substrate and said second substrate; at least two independent electrodes associated with said first substrate; an independent counter-electrode associated with said second substrate; wherein each respective electrode is connected to an independently controllable voltage source; said display device has means for controlling the voltage applied to each respective electrode for producing non-uniform electric fields in each pixel, for causing partial switching of the electrochromic material from a first state to a second state to generate an area-ratio-defined pixel gray level.

2. The display device of claim 1, wherein said display device further has means for controlling the time during which voltage is applied to each respective electrode.

3. The display device of claim 1, wherein said display device further has means for controlling the voltage applied to each respective electrode of the pixel when in the second state, to cause a reset from the second state to the first state.

4. The display device of claim 1, wherein said display device further has memory storage means for storing a previously generated gray level.

5. The display device of claim 4, wherein said display device further has means for comparing a gray level to be achieved with a previously generated gray level.

6. The display device of claim 5, wherein said display device further has means for determining the required potential to be applied to each respective electrode in order to reach a desired gray level.

7. A method for generating analog gray scales in a pixel of a display device having a first substrate, a second substrate and an electrochromic material disposed between said first substrate and said second substrate, the method comprising the steps of:
providing at least two independent electrodes to be associated with said first substrate;
providing an independent counter-electrode to be associated with said second substrate;
providing a connection of each respective electrode to an independently controllable voltage source;
providing means for controlling the voltage applied to each respective electrode for producing non-uniform electric fields in each pixel, for causing partial switching of the electrochromic material from a first state to a second state to generate an area-ratio-defined pixel gray level.

8. The method of claim 7, further comprising the step of:
providing means for controlling the time during which voltage is applied to each respective electrode.

9. The method of claim 7, further comprising the steps of:
providing memory storage means for storing a previously generated gray level;
providing means for comparing a gray level to be achieved with a previously generated gray level;
providing means for determining the required potential to be applied to each respective electrode in order to reach a desired gray level.

10. A computer program product directly loadable into the internal memory of a digital computer comprising software code portions for performing the following steps when said product is run on a computer:
providing a connection to an independently controllable voltage source for at least two independent electrodes of an independently addressable pixel of an electrochromic display device;
providing control of the voltage applied to each respective electrode for producing non-uniform electric fields in each pixel;
providing control of the time during which voltage is applied to each respective electrode.

11. A computer program product stored on a computer-readable storage medium, comprising computer-readable program code means for causing a computer to perform the following steps:
providing a connection to an independently controllable voltage source for at least two independent electrodes of an independently addressable pixel of an electrochromic display device;
providing control of the voltage applied to each respective electrode for producing non-uniform electric fields in each pixel;
providing control of the time during which voltage is applied to each respective electrode.
